(19) United States
(12) Patent Application Publication
(10) Pub. No.: US 2020/0290705 A1
(43) Pub. Date: Sep. 17, 2020

(54) DEVICE FOR THE AUTOMATIC SINKING OF CONTAINERS AND HULLS

(71) Applicants: Giovanni CIALLELLA, Roma (IT); Alessandro MULARGIA, Roma (IT)

(72) Inventors: Giovanni CIALLELLA, Roma (IT); Alessandro MULARGIA, Roma (IT)

(21) Appl. No.: 16/082,200

(22) PCT Filed: Feb. 22, 2017
(86) PCT No.: PCT/IB2017/051013

§ 371 Date: Sep. 4, 2018

(30) Foreign Application Priority Data
Mar. 3, 2016 (IT) 102016000022224

(51) Int. Cl. B63B 13/02; G05D 7/06; F16K 27/00; B65D 88/12; B65D 90/22

(52) U.S. Cl. CPC B63B 13/02; G05D 7/0652; B65D 90/22; B65D 88/121; F16K 27/00

(57) ABSTRACT

Disclosed is a device for the automatic sinking of containers and hulls, including: valves, installed in a first closed configuration and having an airtight seal, susceptible of assuming a second configuration that is irreversibly opened when the external pressure exceeds a predetermined tolerance threshold, the second open configuration being adapted to make air exit from the internal space and make water enter from the outside, the at least two valves being positioned in proximity to two edges, opposite each other, belonging to two lateral surfaces of a container; support which surrounds each valve and adheres to the lateral surface of the container, by way of a coupling system that is adapted to ensure impermeability; protection grids, one placed on the outer side and one on the inner side of each valve, adapted to protect from impact and from extraneous objects which could compromise the functioning thereof.

### FIELD OF THE ART

The present invention operates in the maritime transport field, in particular for the transport of goods, still more in detail in the field of containers and cargo ships.

### PRIOR ART

The introduction of the container dates to an invention of 1956, when an American entrepreneur in the transport field realized that it is much faster to use a transport system in which the goods are loaded only once inside the container and are transported together with the latter. In this manner, the load sustains less damage, the logistics operations are optimized and the loading and unloading from the transport means is much faster. At the start of the 1970s, the standards of the field were defined, which presently have produced the ISO container definition: this is a metal parallelepiped whose measurements were established as 244 cm×259 cm×610 or 1220 cm. The connections present on the corners of the container are also uniform, and are specific for fixing on the various transport means. In this manner, by means of forklifts, bridge cranes or other cranes, the containers and connections can be easily transferred between a ship, a freight car or a truck. The characteristics of these connections, together with the intrinsic strength of the container, allow the stacking together thereof, improving the use of wharfs, docks and warehouses.

For particular uses, also ISO refrigerator tank containers are available, with openable roof or openable lateral walls.

Currently, the importance of containers in the maritime transport field has reached a level such that about 90% of goods is transported by sea through the use of about 200 million containers per year.

The main problem regarding the travels carried out by all these containers consists of the fact that for various reasons, some containers fall in the sea during transportation and start to float on the water surface for many days, without being seen by radar. On average, a container floats for 60 to 170 days before sinking, in accordance with the size of the load. In this time span, they can cover great distances, representing a serious risk for other ships and for oil and natural gas platforms situated at sea.

Various solutions are already known which assist the floating of the containers in order to speed up the costly search and recovery operations.

For example, the Chinese patent CN 103381943 A of 2013 describes a particular type of container provided with a floating device that is automatically inflated when it detects the presence of water. In reality, however, these containers dispersed at sea are left drifting until they naturally sink, given the very high costs required in order to recover them. Object of the present invention is to propose a device applicable to all existing containers, and possibly to any one hull, adapted to allow the automatic sinking of these objects dispersed at sea, in order to avoid risks for ships and maritime platforms.

### DESCRIPTION OF THE INVENTION

According to the present invention, a device is made for the automatic sinking of containers and hulls dispersed at sea with the object of sinking ISO containers of any size and possible regatta boats dispersed at sea, e.g. regatta hulls, in a safe and quick manner, removing floating obstacles from maritime sailing/navigation.

Advantageously said sinking device is constituted at least by a pair of valves 2 positioned in proximity to two opposite edges belonging to two lateral surfaces 1.1 of any one container 1. Such positioning is due to the fact that, given the impossibility of providing for the final floating configuration of a dispersed container 1, there will be in any case at least one valve 2 placed in proximity to the sea level. This characteristic advantageously allows the exit of air from the interior of the container up to the sinking thereof.

Advantageously said valves 2 are installed in a first closed configuration, which ensures the airtight seal of the container 1, and are adapted to irreversibly assume a second open configuration when the external pressure exceeds a predetermined tolerance threshold. Said irreversibly open second configuration is advantageously adapted to allow the entrance of water inside the container 1 and the outward exit of air, up to a condition of equilibrium between the two fluids, given by the total sinking of the container 1.

Advantageously, said valves 2 can be connected to a centralized pressure sensor 2.4, adapted to make all the installed valves 2 simultaneously assume the second open configuration, when a pressure is detected that is beyond a certain tolerance threshold. Said tolerance threshold will be such to determine the opening of the valves 2 only when the entire container 1, or part thereof, is immersed in a liquid, specifically in the sea.

Advantageously other valves 2 can also be arranged in a free position on the lateral surfaces 1.1, on the openable surface 1.2, on the cover 1.3 and on the base 1.4.

If at least one pair of the already-described valves 2 is installed on a hull 3, these will be advantageously connected to a remote control device 5 of a user. In this manner, in case of abandonment for any reason, the user can cause the sinking of the hull 3 by acting on said control device 5 which, remotely, is capable of causing the irreversible opening of the valves 2 and hence the entrance of water into the hull 3 and the exit of air.

Advantageously, also in the case of a hull 3, the positioning of the valves 2 will be such that they are diametrically opposite each other, in a manner such that whatever the positioning of the hull 3 on the water, at least one valve 2 is present placed at the level of the sea.

Advantageously, more than two valves 2 can be installed on any part of a hull 3.

In the case of installation of said valves 2 on a hull 3, these can advantageously be connected to an activation device 4, remotely connected to said control device 5, adapted to cause the irreversible and simultaneous opening of all the valves 2 present on the boat. One of the further advantages of this possible embodiment consists of the fact that it is possible to connect multiple activation devices 4, installed on different hulls 3, to a same remote control device 5, so as to be able to cause the sinking of all the hulls of a multihull craft. Advantageously, said valves 2 are mounted on a support 2.1 which completely surrounds them and stably and irreversibly connects them to the container 1 or to the hull 2 by means of a common coupling system 2.2. Said support 2.1 can advantageously be made of any natural or synthetic polymer, provided with sufficient mechanical strength and resistance to chemical and atmospheric agents; preferably, a polymer will be used that is similar or equivalent to the surface of the container 1 or of the hull 3 on which the valve 2 is installed. Advantageously, said common coupling system 2.2 can be constituted by a welding, by a connection by means of rivets or pins, by a gluing by means of resin or glue, or by any other system known to a man skilled in the art, adapted to irreversibly fix said support 2.1 to the container 1 or to the hull 3.

Advantageously each of said valves 2 is protected by a pair of grids 2.3, one placed on the outer side and one on the inner side of said valve 2 and adapted to protect the relative valve from impact and extraneous bodies that could be stuck thereon.

### DESCRIPTION OF THE FIGURES

The invention will be described hereinbelow in at least one preferred embodiment by way of a non-limiting example, with the aid of the enclosed figures, in which:

FIG. 1 illustrates a three-dimensional view of a container 1 constituted by three lateral surfaces 1.1, an openable surface 1.2, a cover 1.3 and a base 1.4, in which two valves 2 are seen which are placed on opposite edges of two lateral surfaces 1.1 and constituted by a support 2.1, a coupling system 2.2 and the relative grids 2.3; the pressure sensor 2.4 connected to both valves 2 is also visible;

FIG. 2 illustrates a plurality of two-dimensional drawings representing the perspective views of a container provided with the sinking device, in particular FIG. 2A shows the cover 1.3 on which four circular valves 2 are installed at the four corners; FIG. 2B shows a longitudinal lateral surface 1.1 on which four circular valves 2 are installed at the four corners; FIG. 2C shows the base 1.4 on which valves 2 are not installed; FIG. 2D shows the openable surface 1.2 on which installed valves 2 are not installed; FIG. 2E shows the transverse lateral surface 1.1 on which four circular valves 2 are installed at the four corners;

FIG. 3 shows a three-dimensional view of a hull 3 provided with two valves 2 connected to an activation device 4 remotely connected to a control device 5; each valve 2 is constituted by a support 2.1, a coupling system 2.2 and a pair of protection grids 2.3.

### DETAILED DESCRIPTION OF THE INVENTION

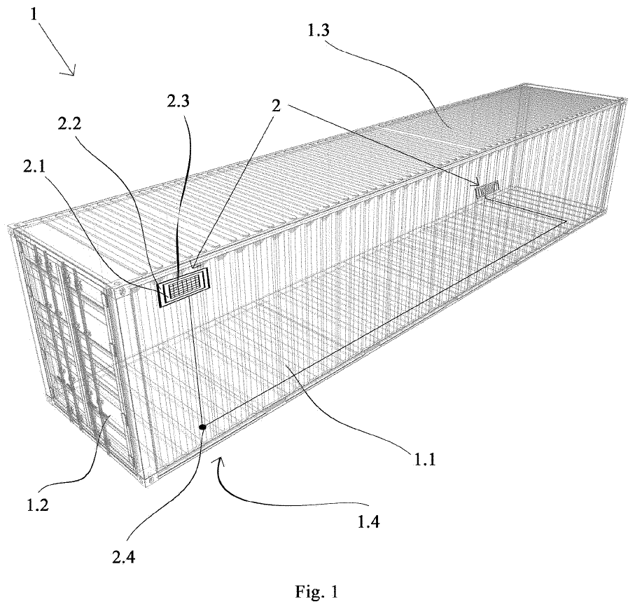

With reference to FIG. 1, a common ISO container 1 is represented, provided with the automatic sinking device that is the object of the present invention.

Such device is composed of at least two valves 2 placed at the opposite edges of two lateral surfaces 1.1 of a container 1. Said valves 2 are surrounded by a support 2.1, preferably made of the same material as the surface on which it adheres by means of a common coupling system 2.2. Specifically, if the valve 2 is installed on the lateral surface 1.1 of a container 1, the support 2.1 will preferably made of metal plate; if instead the valve 2 is installed on a hull 3, the support 2.1 will be made of aluminum or fiberglass-reinforced plastic in accordance with the construction method of the hull 3 itself. The objective of said support 2.1 is to provide mechanical strength and resistance to atmospheric and chemical agents to the entire valve 2.

Depending on the material constituting both the support 2.1 and the container 1 or the hull 3, said valve 2 will be provided with the suitable coupling system 2.2 which irreversibly connects it to the container 1 or to the hull 3. Said coupling system 2.2 can be, by way of a non-limiting example, a welding, a plurality of pins or rivets or any one glue.

Still with reference to FIG. 1, one sees that both the inner surface and the outer surface of the valve 2 is protected by a grid 2.3 which, in addition to providing resistance to accidental impact, prevents any extraneous object from being inserted in the open valve 2, blocking the flow of air or water.

Said valves 2—and of course more than two of these can also be present—are adapted to be automatically opened when they detect an external pressure that exceeds a certain tolerance threshold. The opening, which is irreversible, causes the entrance of water and the exit of air from the interior of the container 1 or of the hull 3 and causes the quick sinking thereof.

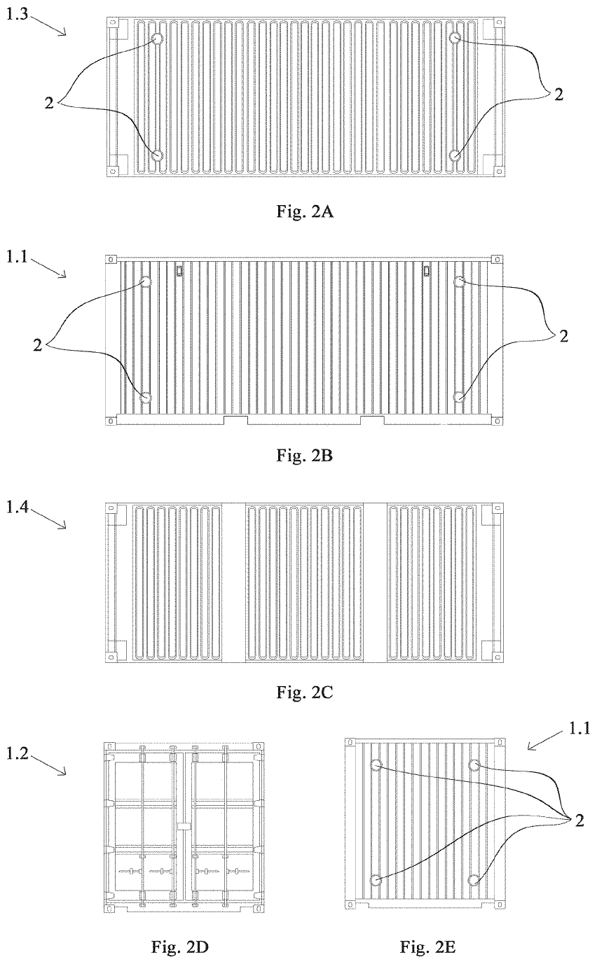

With reference to FIG. 2, the six sides are shown which constitute a common ISO container 1. In this preferred embodiment, by way of a non-limiting example, valves 2 are used with cylindrical shape, which are positioned at the four corners of the cover 1.3 and at the four corners of all the lateral surfaces 1.1, the two longitudinal surfaces as well as the bottom transverse surface. The only two surfaces on which valves 2 are not installed are the openable surface 1.2 and the base 1.4 of the container 1.

In order to be certain of device functioning, it is also possible to install double valves 2, i.e. constituted by two separate openings, adapted to be irreversibly opened when a pressure is detected that is greater than a tolerance threshold. In this manner, in case of lack of functioning of one of the two openings, for any reason, the functioning of the valve 2 will be ensured by the opening of the other opening.

In the case of a container 1, which in normal conditions travels not in contact with water, it is possible to connect the opening of the valves 2 to a pressure sensor 2.4 which, when it detects an external pressure higher than the tolerance threshold, simultaneously and irreversibly opens all the valves 2.

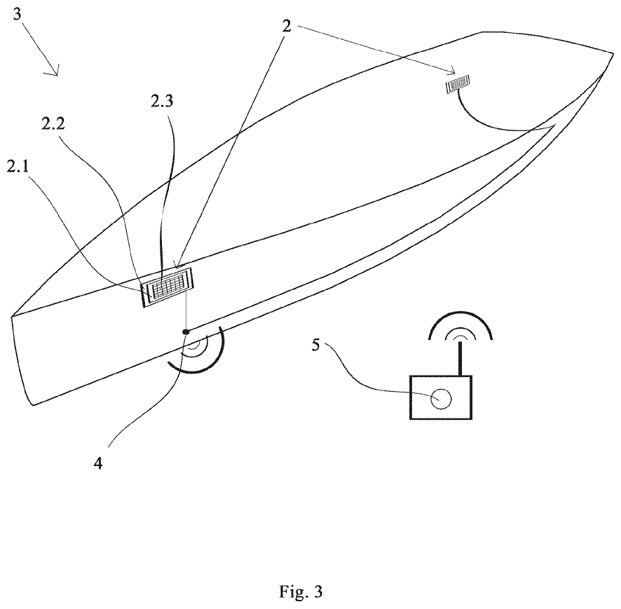

Said pressure sensor 2.4 is not applicable to a hull 3, since the latter is still at least partially immersed in water. As represented in FIG. 3, the valves 2 of an automatic sinking system applied to a hull 3 are connected to an activation device 4 which simultaneously and irreversibly opens all the valves 2 upon remote control of a control device 5 actuated by a user.

If the boat is composed of more than one hull 3 (in the case of a catamaran or a trimaran), the control device 5 can be remotely connected to more than one activation device 4, each situated in a different hull 3 and connected to the valves 2 relative to that hull 3. In this manner, in the case of a naval disaster, after having saved the entire crew, one can decide to sink the hull 3 or hulls 3 of a boat, in order to prevent their drifting on the sea from forming a sailing/navigation danger.

Finally, it is clear that in the invention described up to now, there can be modifications, additions or variants that are obvious for a man skilled in the art, without departing from the protective scope which is provided by the enclosed claims.

1. Device for the automatic sinking of containers and hulls, further comprising:
A) a pair of valves (2), installed in a first closed configuration and having airtight seal, susceptible of assuming a second configuration that is irreversibly opened when the external pressure exceeds a predetermined tolerance threshold, said second open configuration being adapted to make air exit from the internal space and make water enter from the outside, said at least two valves (2) being positioned in proximity to two edges, opposite each other, belonging to two lateral surfaces (1.1) of a common container (1);
B) a support (2.1) adapted to surround each of said valves (2) and to stably adhere to the lateral surface (1.1) of the container (1), by means of any one coupling system (2.2) commonly found on the market that is adapted to ensure impermeability;
C) a pair of protection grids (2.3), one placed on the outer side and one on the inner side of each valve (2), adapted to protect the corresponding valve (2) from accidental impact and from extraneous objects that, being stuck therein, could compromise the functioning thereof.

2. Device for the automatic sinking of containers and hulls, according to claim 1, wherein said container (1) is provided with a plurality of valves (2) freely arranged on its lateral surfaces (1.1), on its openable surface (1.2), on its cover (1.3) and on its base (1.4), arranged in a manner such that, regardless of the position of the container (1) in the sea, at least one valve (2) is placed on the surface closer to the water surface.

3. Device for the automatic sinking of containers and hulls, according to claim 1, wherein the support (2.1) of each valve (2) is made of any natural or artificial polymer, adapted to resist mechanical stresses, chemical and atmospheric agents and adapted to be irreversibly fixed with the surface of the container (1) on which the valve (2) is installed.

4. Device for the automatic sinking of containers and hulls, according to claim 1, wherein all the valves (2) installed on the same container (1) are connected to a pressure sensor (2.4), adapted to simultaneously make all said valves (2) assume said second open configuration when an external pressure is detected that exceeds a specific tolerance threshold.

5. Device for the automatic sinking of containers and hulls, further comprising:
A) a pair of valves (2), installed in a first closed configuration having an airtight seal, susceptible of assuming a second irreversibly open configuration upon remote control of the user, said second open configuration being adapted to make air exit from the internal space and to make water enter from outside, said at least two valves (2) being positioned in at least two diametrically opposite points of any one hull (3);
B) a support (2.1) adapted to surround each of said valves (2) and to stably adhere to the hull (3), by means of any one coupling system (2.2) commonly found on the market, adapted to ensure impermeability;
C) a pair of protection grids (2.3), one placed on the outer side and one on the inner side of each valve (2), adapted to protect the corresponding valve (2) from accidental impact and from extraneous objects which, by being stuck therein, could comprise the functioning thereof.

6. Device for the automatic sinking of containers and hulls, according to claim 5, wherein said hull (3) is provided with a plurality of valves (2) freely arranged on its surface, arranged in a manner such that, regardless of the position of the hull (3) in the sea, at least one valve (2) is placed at the water surface.

7. Device for the automatic sinking of containers and hulls, according to claim 5, wherein the support (2.1) of each valve (2) is made of any natural or artificial polymer, adapted to resist mechanical stresses, chemical and atmospheric agents and adapted to be irreversible fixed with the surface of the hull (3).

8. Device for the automatic sinking of containers and hulls, according to claim 5, wherein all the valves (2) installed on the same hull (3) are connected to an activation device (4) adapted to simultaneously make all said valves (2) assume said second open configuration; said activation device (4) remotely connected to a common control device (5) actuated by a user.

9. Device for the automatic sinking of containers and hulls, according to claim 8, wherein the control device (5) is remotely connected to at least two activation devices (4) installed on different hulls (3).

10. Device for the automatic sinking of containers and hulls, according to claim 1, wherein said coupling system (2.2) can be constituted by a welding, by a plurality of rivets or by any one glue that can be found on the market or by any other system adapted to irreversibly and sealingly fix the valve (2) with the relative support (2.1) to the surface of the container (1) or of the hull (3) and to maintain the impermeability and strength over time.

11. Device for the automatic sinking of containers and hulls, according to claim 2, wherein the support (2.1) of each valve (2) is made of any natural or artificial polymer, adapted to resist mechanical stresses, chemical and atmospheric agents and adapted to be irreversibly fixed with the surface of the container (1) on which the valve (2) is installed.

12. The device of claim 3, wherein the support comprises a type of metal plate that constitutes the surfaces of the container (1).

13. Device for the automatic sinking of containers and hulls, according to claim 2, wherein all the valves (2) installed on the same container (1) are connected to a pressure sensor (2.4), adapted to simultaneously make all said valves (2) assume said second open configuration when an external pressure is detected that exceeds a specific tolerance threshold.

14. Device for the automatic sinking of containers and hulls, according to claim 3, wherein all the valves (2) installed on the same container (1) are connected to a pressure sensor (2.4), adapted to simultaneously make all said valves (2) assume said second open configuration when an external pressure is detected that exceeds a specific tolerance threshold.

15. Device for the automatic sinking of containers and hulls, according to claim 6, wherein the support (2.1) of each valve (2) is made of any natural or artificial polymer, adapted to resist mechanical stresses, chemical and atmospheric agents and adapted to be irreversible fixed with the surface of the hull (3).

16. The device of claim 7, wherein the support comprises the same polymer that constitutes the hull (3).

17. Device for the automatic sinking of containers and hulls, according to claim 6, wherein all the valves (2) installed on the same hull (3) are connected to an activation device (4) adapted to simultaneously make all said valves (2) assume said second open configuration; said activation device (4) remotely connected to a common control device (5) actuated by a user.

18. Device for the automatic sinking of containers and hulls, according to claim 7, wherein all the valves (2) installed on the same hull (3) are connected to an activation device (4) adapted to simultaneously make all said valves (2) assume said second open configuration; said activation device (4) remotely connected to a common control device (5) actuated by a user.

19. Device for the automatic sinking of containers and hulls, according to claim 2, wherein said coupling system (2.2) can be constituted by a welding, by a plurality of rivets or by any one glue that can be found on the market or by any other system adapted to irreversibly and sealingly fix the valve (2) with the relative support (2.1) to the surface of the container (1) or of the hull (3) and to maintain the impermeability and strength over time.

20. Device for the automatic sinking of containers and hulls, according to claim 3, wherein said coupling system (2.2) can be constituted by a welding, by a plurality of rivets or by any one glue that can be found on the market or by any other system adapted to irreversibly and sealingly fix the valve (2) with the relative support (2.1) to the surface of the container (1) or of the hull (3) and to maintain the impermeability and strength over time.
